(19) United States
(12) Patent Application Publication
(10) Pub. No.: US 2017/0316417 A1
(43) Pub. Date: Nov. 2, 2017

(54) SYSTEMS AND METHODS FOR INCENTIVIZING TRANSACTIONS

(71) Applicants: Yu-Hsuan Wang, San Francisco, CA (US); Gopalakrishnan Venkatasubramanian, San Francisco, CA (US); Brian Weiner, Thornhill (CA); Diego Valera, San Francisco, CA (US); Stephanie Ericksen, Foster City, CA (US)

(72) Inventors: Yu-Hsuan Wang, San Francisco, CA (US); Gopalakrishnan Venkatasubramanian, San Francisco, CA (US); Brian Weiner, Thornhill (CA); Diego Valera, San Francisco, CA (US); Stephanie Ericksen, Foster City, CA (US)

(21) Appl. No.: 15/141,545

(22) Filed: Apr. 28, 2016

(51) Int. Cl. G06Q 20/40; G06Q 30/02

(52) U.S. Cl. CPC G06Q 20/4097; G06Q 30/0232

(57) ABSTRACT

A method of incentivizing secure transactions that includes receiving future travel location data and future travel time data. The method includes determining bonus multiplier information based on the travel details, where the bonus multiplier information is indicative of a bonus multiplier. The method includes transmitting the bonus multiplier information to a user computing device. The method includes receiving a transaction authorization request associated with a transaction. The transaction authorization request includes transaction location data and transaction time data, and the transaction authorization request includes a transaction amount. The method includes verifying that the transaction location data matches the travel location data and that the transaction time data matches the travel time data. The method includes transmitting an authorization response via the payment network and determining a new rewards points amount by applying the bonus multiplier to the transaction amount.

### BACKGROUND

When traveling, especially traveling internationally, currencies can frequently be in unfamiliar denominations with constantly changing exchange rates, and items for purchase may or may not have a similar value to comparable items purchased at home. For these reasons, it may be difficult for international travelers to keep track of spending and determining what modes of payment are best in a particular situation in a particular country. Additionally, carrying cash internationally can lead to difficulties in exchanging currencies and being stuck with a foreign currency at the end of a trip. Further, while credit cards may offer an alternative to using local cash currency, problems can arise for credit card issuers in determining whether an international purchase is a legitimate one made by an authorized credit card user, or a fraudulent purchase or charge.

A system and methods are needed that allow for more effective tracking of spending and that provides incentive for a user to use a credit card while traveling and to inform the credit card issuer of that travel.

### SUMMARY

In one embodiment, the disclosure describes a computer-implemented method of incentivizing secure transactions. The method includes receiving, via a digital communication network, an input of future travel details including future travel location data and future travel time data from a user via a user computing device. The method also includes transmitting travel details to an offer server, where the offer server is associated with a payment card issuer. The method also includes determining, via one or more processors, bonus multiplier information based on the travel details, where the bonus multiplier information is indicative of a bonus multiplier. The method includes transmitting, via the digital communication network, the bonus multiplier information to the user computing device. The method includes receiving, via a payment network, a transaction authorization request associated with a user-initiated transaction. The transaction authorization request includes transaction location data and transaction time data, and the transaction authorization request includes a transaction amount. The method also includes verifying, via one or more processors, that the transaction location data matches the travel location data and that the transaction time data matches the travel time data. The method includes transmitting an authorization response via the payment network and determining, via the one or more processors, a new rewards points amount by applying the bonus multiplier to the transaction amount.

In another embodiment, the disclosure describes a computer-implemented method of incentivizing secure transactions. The method includes receiving, via a digital communication network, future travel location data and future travel time data from a user computing device. The method includes determining, via one or more processors, a bonus multiplier based on the future travel location data and the future travel time data. The method also includes transmitting, via the digital communication network, bonus multiplier information to the user computing device, where the bonus multiplier information is indicative of the bonus multiplier and includes at least one eligible merchant category. The method includes receiving, via a payment network, a transaction authorization request associated with a transaction. The transaction authorization request includes transaction location data and transaction time data, a transaction amount, and merchant category information indicative of a merchant category. The method also includes determining, via the one or more processors, that the transaction location data matches the travel location data and that the transaction time data matches the travel time data. Based on the determination that the transaction location data matches the travel location data and that the transaction time data matches the travel time data, the method includes transmitting an authorization response via the payment network. The method also includes determining, via the one or more processors, that the merchant category indicated by the merchant category information matches the at least one eligible merchant category. Based on the determination that the merchant category indicated by the merchant category information matches the at least one eligible merchant category, determining, via the one or more processors, a new rewards points amount by applying the bonus multiplier to the transaction amount.

In yet another embodiment, the disclosure describes a computer-implemented method of incentivizing secure transactions. The method includes receiving, via a digital communication network, an input of future travel details including future travel location data and future travel time data from a user via a user computing device. The method also includes transmitting travel details to an offer server, the offer server being associated with a payment card issuer. The method includes determining, via one or more processors, bonus multiplier information based on the travel details, the bonus multiplier information being indicative of a bonus multiplier, and transmitting, via the digital communication network, the bonus multiplier information to the user computing device. The method also includes receiving, via a payment network, a transaction authorization request associated with a transaction. The transaction authorization request includes transaction location data and transaction time data. The method also includes determining, via one or more processors, at least one of that the transaction location data does not match the future travel location data or that the transaction time data does not match the travel time data. Based on the determination that either the transaction location data does not match the future travel location data or that the transaction time data does not match the travel time data, the method includes transmitting a transaction denial via the payment network.

### BRIEF DESCRIPTION OF THE DRAWINGS

The invention may be better understood by reference to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is an illustration of the elements of an embodiment of a system for incentivizing transactions as shown and described herein;

FIG. 2 is an illustration of a computerized method of incentivizing transactions as shown and described herein;

FIG. 3 is an illustration of another embodiment of incentivizing transactions as shown and described herein;

FIG. 4 is an schematic illustration of elements of an embodiment of a portable computing device;

FIG. 5 is a schematic illustration of elements of an embodiment of a server type computing device;

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### SPECIFICATION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense.

It is not uncommon for a consumer possess or have accounts with multiple banks or with multiple credit card issuers. Software tools and applications can used to more easily keep track of the accounts associated with each credit card or issuing bank, or even to keep track of the use of a single credit card by one or multiple users. Some of these applications can store credit card information for quickly filling in information when making electronic purchases, and certain computing or mobile devices and software applications that include credit card information can be used to make electronic or even real-world purchases. In such instances, the computing device can be equipped with features need to perform some form of wired or wireless communication with a seller or seller's own device. For example, some computing devices may use near field communication (NFC) to establish wireless communication with a another device in order to exchange the information required to complete a transaction. Other suitable wireless communication protocols may be used as well, such as WiFi, 802.11, Bluetooth, BLE, infrared, etc. In some such embodiments, software tools or applications running on the computing device may contain the credit card or banking information needed to make a transaction, and may be controlled by a user to implement the wireless communication transaction when appropriate.

In many situations, for security purposes, it may not be desirable for a computing device or the software running on the computing device to transmit actual credit card credentials that could independently be used to complete a transaction, and a secure token transaction process may be implemented. In an embodiment of such a process, the computing device or software may transmit only an encrypted or coded token that represents the payment card credentials and is decipherable by an authorized third party, but is otherwise useless to any unauthorized third parties attempting to steal the payment card information. Once the coded token is verified and the payment card issuer completes authorization and validation procedures, the payment card issuer may transmit an authorization confirmation back to the merchant and a message indicating the success or failure of the transaction may be sent to the computing device.

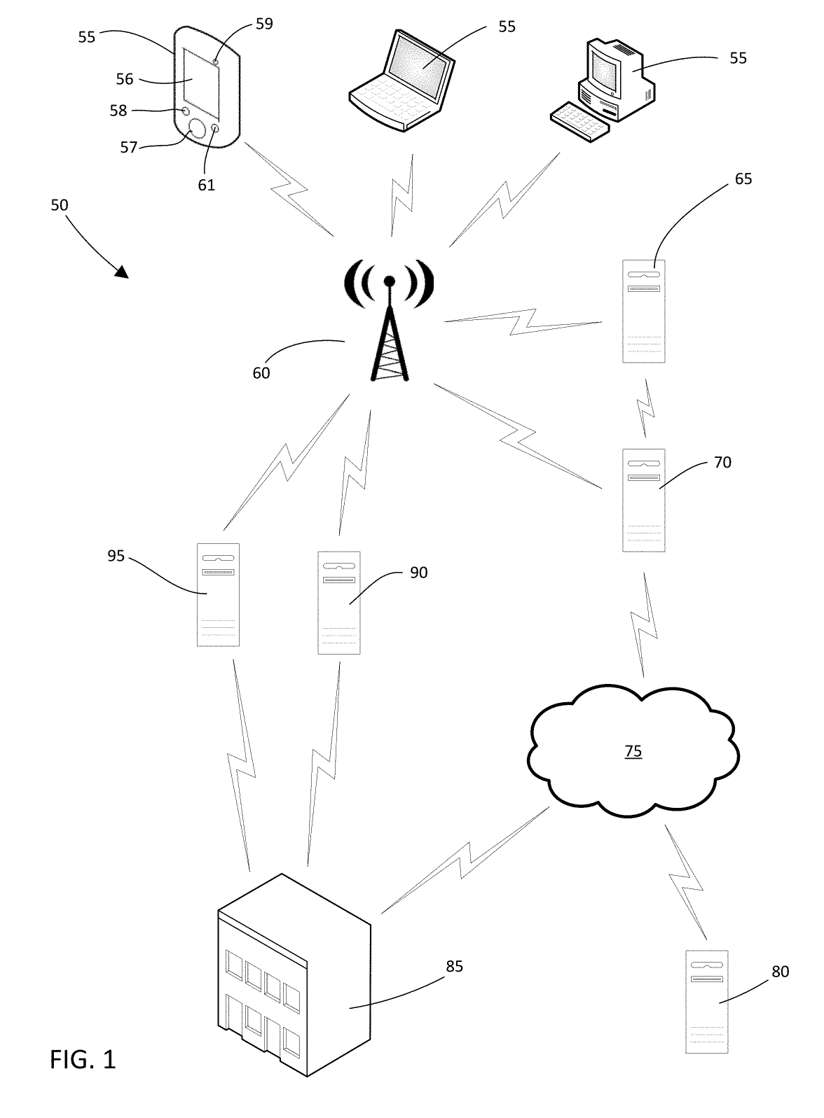

A high level illustration of some of the elements in a sample computing system 50 that may be physically configured to implement the secure token transaction process and system for international travel incentives is illustrated in FIG. 1. The system 50 may include any number of computing devices 55, such as a smart phone or tablet computer, a mobile computing device, a wearable mobile device, a desktop computer, a laptop computer, or any other computing device that allows a user to interface with a digital communications network, such as digital communication network 60. Connection to the digital communication network 60 may be wired or wireless, and may be via the internet or via a cellular network or any other suitable connection service. Various other computer servers may also be connected to via the digital communication network 60, such as an e-commerce enabler server 65, a merchant server 70, a points server 90, an offer server 95, a card issuer 85, and a token server 80. Various of these servers or computer entities may also be connected through a secure payment network 75. The payment network 75 may be an electronic payment system used to accept, transmit, or process transactions made by users with payment cards for money, goods, or services, and to transfer information and funds among payment card issuers, merchants, payment card holders, payment processors, acquirers, etc. In the illustrated embodiment, at least the merchant server 70, the token server 80, and the card issuer 85 may be connected via the payment network 75, but it is contemplated that other entities, such as the e-commerce enabler 65 or an acquirer may be connected as well.

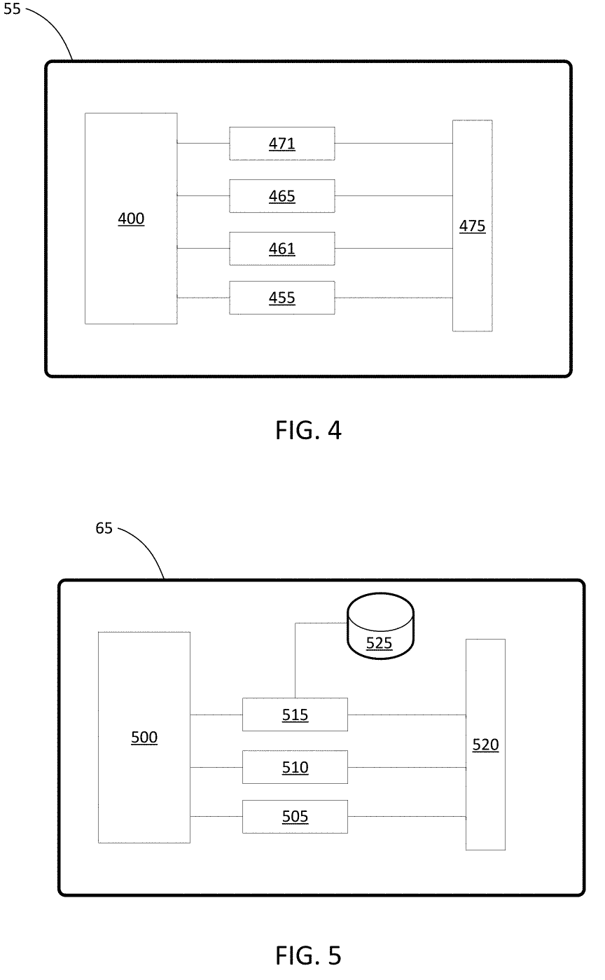

In one embodiment, the computing device 55 may be a device that operates using a portable power source 455, as shown in FIG. 4, such as a battery. The computing device 55 may also have a display 56 which may or may not be a touch sensitive display. More specifically, the display 56 may have a capacitance sensor, for example, that may be used to provide input data to the computing device 55. In other embodiments, an input pad 57 such as arrows, scroll wheels, keyboards, etc., may be used to provide inputs to the computing device 55. In addition, the computing device 55 may have a microphone 58 which may accept and store verbal data, a camera 59 to accept images and a speaker 61 to communicate sounds.

The computing device 55 may be able to communicate with a computer server or a plurality servers, such as the e-commerce enabler server 65 and the merchant server 70. The computing device 55 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the server or may be through a digital communication network 60 such as cellular service, through the Internet, through a private network, through Bluetooth, etc.

FIG. 4 is a simplified illustration of the physical elements that make up an embodiment of a computing device 55 and FIG. 5 is a simplified illustration of the physical elements that make up an embodiment of a server type computing device, such as the e-commerce enabler server 65, but the merchant server 70, points server 90, offer server 95, and token server 80 may reflect similar physical elements in some embodiments. Referring to FIG. 4, a sample computing device 55 is illustrated that is physically configured according to be part of the computing system 50 shown in FIG. 1. The portable computing device 55 may have a processor 451 that is physically configured according to computer executable instructions. In some embodiments, the processor can be specially designed or configured to optimize communication between the server 65 and the computing device 55 relating to the e-commerce enabler application and rewards incentive system discussed herein. The computing device 55 may have a portable power supply 455 such as a battery which may be rechargeable. It may also have a sound and video module 461 which assists in displaying video and sound and may turn off when not in use to conserve power and battery life. The computing device 55 may also have volatile memory 465 and non-volatile memory 471. The computing device 55 may have GPS capabilities that may be a separate circuit or may be part of the processor 451. There also may be an input/output bus 475 that shuttles data to and from the various user input/output devices such as a microphone, the camera 108, a display 102, or other input/output devices. The portable computing device 101 also may control communicating with the networks, such as communication network 121 in FIG. 1, either through wireless or wired devices. Of course, this is just one embodiment of the portable computing device 101 and the number and types of portable computing devices 101 is limited only by the imagination.

The physical elements that make up an embodiment of a server, such as the e-commerce enabler server 65, are further illustrated in FIG. 5. In some embodiments, the e-commerce enabler server is specially configured to run the e-commerce enabler engine as described herein. At a high level, the server 65 may include a digital storage such as a magnetic disk, an optical disk, flash storage, non-volatile storage, etc. Structured data may be stored in the digital storage such as in a database. More specifically, the server 65 may have a processor 500 that is physically configured according to computer executable instructions. In some embodiments, the processor 500 can be specially designed or configured to optimize communication between a portable computing device, such as computing device 55, and the server 65 relating to the e-commerce enabler application and reward points incentive system as described herein. The server 65 may also have a sound and video module 505 which assists in displaying video and sound and may turn off when not in use to conserve power and battery life. The server 65 may also have volatile memory 510 and non-volatile memory 315.

A database 525 for digitally storing structured data may be stored in the memory 510 or 515 or may be separate. The database 525 may also be part of a cloud of servers and may be stored in a distributed manner across a plurality of servers. There also may be an input/output bus 520 that shuttles data to and from the various user input devices such as a microphone, a camera, a display monitor or screen, etc. The input/output bus 520 also may control communicating with the networks, such as communication network 60 and payment network 75, either through wireless or wired devices. In some embodiments, the e-commerce software application running the rewards points incentive engine may be located on the computing device 55. However, in other embodiments, the application may be located on e-commerce server 55, or both the computing device and the server 65. Of course, this is just one embodiment of the e-commerce server 65 and additional types of servers are contemplated herein.

In the embodiment illustrated in FIG. 1, the e-commerce enabler server 65 may be connected to the merchant server 70 either through the digital communication network 60 or through other connections. In some embodiments, the merchant server 70 may be associated with any type of merchant offering goods or services for purchase with payment cards, whether those purchases are online or otherwise. For online purchases, the merchant server 70 or a group of servers may host a merchant website where the merchant's goods or services may be purchases by a consumer. In some embodiments, the merchant's website may include a button or other trigger on the merchant's payment page that may initiate a checkout process via the e-commerce enabler as hosted by the e-commerce enabler server 65. In some embodiments, the e-commerce enabler may provide checkout experiences to consumers participating in e-commerce. For example, the e-commerce enabler may collect payment information from the consumer, such as payment card credentials, that may be used for the immediate transactions as well as for future purchases with the same or other merchants. E-commerce enablers may consolidate the entities to which a consumer shares its confidential payment information. Specifically, the consumer may share its payment card information with the e-commerce enabler via software or other interface hosted by the e-commerce enabler, and the e-commerce enabler may provide the relevant payment information to a variety of merchants with whom the consumer would like to transact purchases. In some embodiments, the e-commerce enabler may have particular merchants integrated to the e-commerce enabler.

In some embodiments, a consumer may access the e-commerce enabler server 65 via a computing device 55 such as a smartphone, and may set up an account with the e-commerce enabler. The consumer may provide payment card or banking information for one or more payment cards provided by one or more card issuers. The e-commerce enabler may store such payment card information associated with the consumer's account that can be retrieved at the consumers request to complete e-commerce transactions such as through a merchant's website. Purchases using payment information stored with the e-commerce enabler, however, may occur in any of a variety of ways. For example, a consumer using a mobile computing device 55 may have an application associated with the e-commerce enabler through which the consumer may log on to its account. In some embodiments, the consumer may log onto the e-commerce enabler account via a web browser. The computing device 55 may be equipped with near field communication (NFC) or other wireless technology (e.g., WiFi, 802.11, Bluetooth, Bluetooth Low Energy (BLE), infrared, etc.) that can be accessed and implemented by the e-commerce enabler application. The consumer may select a payment account or card stored through the e-commerce enabler for use performing a given transaction. Using the NFC enabled computing device to connect with merchant's computing device that may be connected to the merchant server 70, the e-commerce enabler application may transmit the relevant payment card information to the merchant server to make payment for a transaction. In this embodiment, the consumer is able to make a purchase via the e-commerce enabler using payment information from one of a possible variety of payment cards without actually needing to use the physical payment card to do so.

In some embodiments, it may be desirable to execute a purchase transaction with additional security that may limit the parties having access to actual payment card information. In some embodiments, this additional security may be provided through “tokens” and token data that may be transmitted between parties instead of the payment card information that could potentially be used to make unauthorized purchases. In some embodiments, a token service provider (TSP) may operate a token server, such as the token server 80 shown in FIG. 1, to provide token services. The token server 80 may be connected to the payment network 75 through which the token server may communicate with at least the merchant server 70 and the payment card issuer 85.

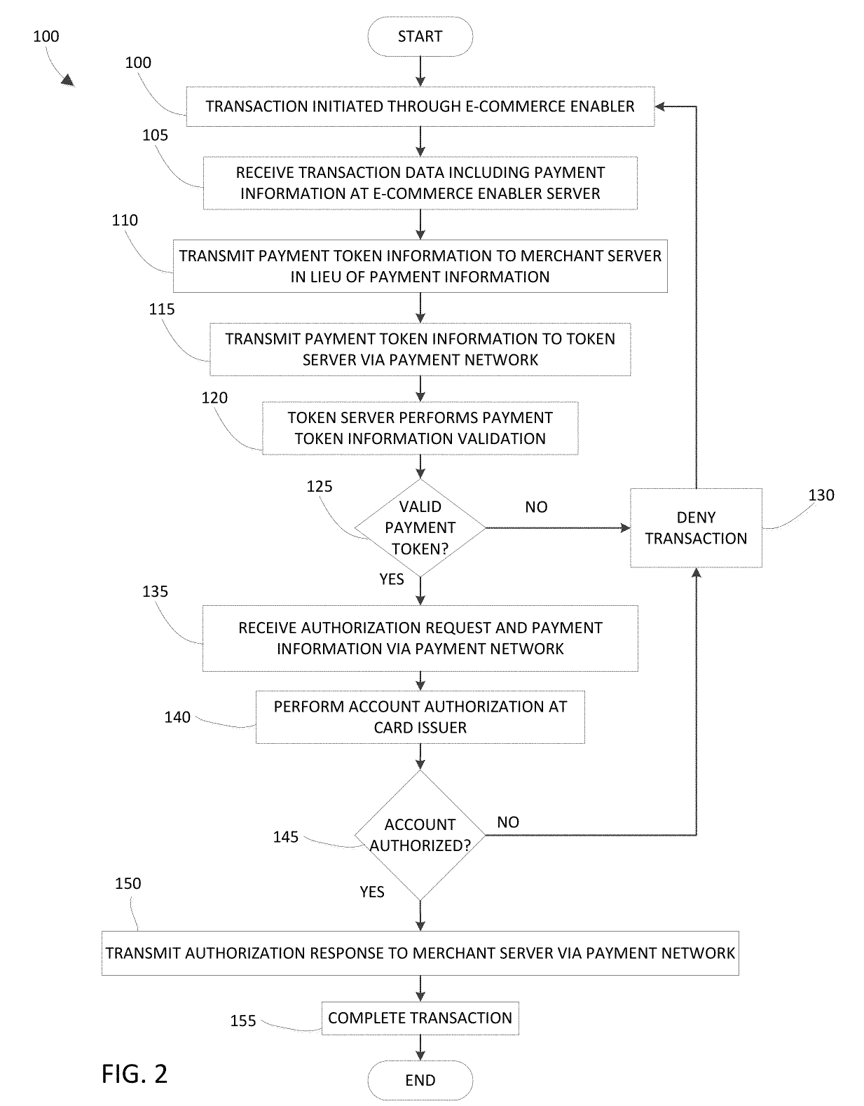

An example of a process 100 by which a purchase transaction may take place using a token system is illustrated by flow chart in FIG. 2. A consumer may initiate a transaction through the e-commerce enabler at block 100. In some embodiments, this transaction may be through a merchant's website, via software on a computing device, or other suitable transaction scenarios. At block 105, the e-commerce enabler server may receive transaction data needed to complete a transaction, which may include payment information associated with the consumer's payment card or payment account. In some embodiments, the payment information may include the account number associated with the payment card or payment account, as well as other authenticating information such as an expiration date, personal identification number (PIN), and/or security code. In some embodiments, the consumer may have directly entered the payment information and other transaction data, but in other embodiments the payment information on other relevant consumer data may be stored on the e-commerce enabler server 65 and associated with the consumer's account or previous transactions. In embodiments in which the payment information may be stored on the e-commerce enabler server 65, the consumer may have selected among a variety of stored payment cards or payment accounts with which to complete transaction.

At 110, instead of transmitting the actual payment information that may be associated with the consumer, the e-commerce enabler may alternatively transmit payment token information to the merchant server 70 in lieu of the payment information. The payment token information may include various information, such as a token expiry date. The merchant may then transmit the payment token information to the payment network 75, and on to the token server 80 via the payment network at block 115. In some embodiments, the merchant server 70 may interface directly with the token server 80, and in other embodiments the merchant server 70 my transmit the payment token information to the payment network 75, which may interface with the token server 80 controlled by the token service provider. In either embodiment, at block 120, the token server 80 may perform payment token information verification to ensure that the payment token information is authentic and truly associated with the payment card or account selected by the consumer. The verification process may include several steps, such as retrieving the actual payment information for the account associated with the payment token information as may be stored on the token server 80, verifying that the payment token is active, and perform any decryption of any encrypted information associated with the payment token. In some embodiments of the verification process, the e-commerce enabler server 65 and the token server 80 may both have stored upon them synchronized and corresponding data for each payment token mapped to the consumer's payment information. For example, a payment token may have a specific activation date and expiry date stored only in authorized locations, such as on the e-commerce enabler server 65 and the token server 80. At any given time, when the e-commerce enabler server 65 submits the payment token information to the merchant server 70 and on to the token server 80, the payment token information submitted from the e-commerce enabler server 65 should match the payment token information stored on the token server 80 for the account associated with the consumer's payment account. If the active payment token information does not match, it may be likely that the transaction was not authorized by the owner of the payment information.

At block 125, if the payment token is found to be invalid or does not match the active payment token information corresponding to the payment account, the transaction may be denied at block 130. If the payment token is found to be valid, then, at block 135, the card issuer 85 may receive an authorization request and payment from the payment network 75 or via the payment network from the token server 80. In some embodiments, the authorization request received by the card issuer 85 will include the actual payment information corresponding to the payment card selected for the transaction, instead of the payment token information. In some embodiments, payment token information may be transmitted to the card issuer 85 as well. It should be understood that, although FIG. 1 shows the token server 80 as separate from the payment network 75, in some embodiments, the token server may tap into the payment network to perform verification of the payment token while the payment token information is routed through the payment network.

At block 140, the payment card issuer 85 may perform an account-level validation and authorization check. If, at block 145, the payment card issuer 85 finds that the account is invalid or that, for example, the account does not have the proper funding or credit to cover the requested transaction, the transaction may be denied at block 130. Alternatively, if the account authorization and validation finds that the account is authorized, then, at block 150, the payment card issuer 85 may transmit an authorization response to the merchant server 70 via the payment network 75. The merchant server 70 may then complete the transaction and inform the consumer and/or the e-commerce enabler 65 that the transaction was successful. In such an embodiment as described relating to the process 100, a consumer may make a secure purchase transaction without ever needing to provide the merchant with the actual payment card information associated with a payment card or account.

In some embodiments, the e-commerce enabler may provide a system for international travel incentives via a software application installed on a user's computing device 55 or through a web application accessed via a web browser. In some embodiments, the software application may provide access to an account kept through the e-commerce enabler with account information stored on the e-commerce enabler server 65. In some embodiments, however, the account information may be stored on the computing device 55 itself. The account information may include information associated with one or more payment cards or payment accounts. For example, if a user has accounts with two different credit card issuers, the user may input or otherwise provide to the application the payment information for each credit card and any other information necessary to complete purchase transactions with those credit card accounts. Then, when the user wishes to initiate a transaction on a merchant website or via other electronic purchasing methods, the e-commerce enabler server 65 will have access to the payment information and the user may select which credit card to use for the particular transaction. The application may then track the usage of each credit card and provide the user with ongoing credit or account balances, or even analysis of spending habits. Additionally, if the user instead uses the physical credit card for a purchase, the application may retrieve from the payment card issuer a report of those purchases such that the e-commerce enabler may provide an accurate account of the user's credit card use for each particular account.

The e-commerce enabler software application may include a module for individual payment card issuers to incentivize the user to report travel plans and to make purchases using a particular card while traveling. In some embodiments, the travel may specifically be international travel. For example, the software application may receive inputs from a user through the computing device 55 indicating that the user will be traveling in a particular location or country over a particular time period. The application may automatically, or upon prompting from the user, transmit a notification to the payment card issuers registered under the user's account with the e-commerce enabler that the user will be in the particular travel destination reported for the timeframe reported. This information about the user's location and duration of stay in that location may aid the payment card issuer in determining whether a transaction initiated in a particular location is an authorized transaction. For example, if a user inputs into the application that the user will be traveling in Paris, France, for the entire month of April, the payment card issuers associated with the user's credit card accounts stored in the application would be aware that transactions made in Paris, France, during the month of April should be expected. Otherwise, without this notification, the transactions may otherwise cause the card issuer to “red-flag” or deny such transactions if the user does not normally make purchases in Paris. In some embodiments, the user may select which of the variety of payment accounts stored with the e-commerce enabler the user plans to use when traveling. For example, if the user has an account with Credit Card A and Credit Card B, and the account information of both credit cards is stored with the e-commerce enabler, the user may use the application to select that the user would only like to use Credit Card A on an upcoming trip, but not Credit Card B.

The application may also be used to manage rewards points associated with each payment card logged with the e-commerce enabler application. In particular, some payment card issuers may offer rewards points to users for purchases made using that card issuer's payment card. For example, a payment card issuer may provide one rewards “point” for every dollar (or equivalent amount of another monetary denomination) spent on purchases using the card issuer's payment card. The rewards points earned by a user may be accumulated and tracked by the payment card issuer. The payment card issuer may then offer any of a variety of ways to redeem the user's accumulated rewards points, for example, by offering cash value for a predetermined amount of rewards points, or by offering goods or service for purchase in exchange for rewards points instead of in exchange for dollars. Whatever manner in which the payment card issuer offers to redeem points, it may generally be advantageous for a user to accrue as many points as possible so as to redeem the points in exchange for goods and services.

Referring again to FIG. 1, in some embodiments, the amount of points a user has accrued using a particular payment card may be stored on a points server 90. The points server may receive notification from the card issuer when purchase transactions are made using the card issuer's 85 payment card, and the points server 90 may update a points database of user reward points to reflect the most recent purchases. Additionally, when a user redeems reward points, the card issuer 85 may notify the points server 90 to adjust the points database to reflect that the user no longer has access to the redeemed points. Although FIG. 1 shows the points server 90 as separate from the card issuer 85, it is contemplated that, in some embodiments, the points server is disposed within the card issuer, is one of multiple points servers. In some embodiments, the e-commerce enabler server 65 may receive rewards points information from the points server 90 either directly or through the digital communication network 60. The e-commerce enabler application may then include a points module to display to the user via its computing device 55 the accumulated reward points that a user has earned for purchases made through that payment card account. In some embodiments, depending on the offerings from the specific payment card issuer, the e-commerce enabler may allow a user use reward points for qualifying transactions instead of dollars or equivalent currency.

Once the user has selected one or more payment cards and the e-commerce enabler has transmitted the indicated travel destination and time duration to the selected payment card issuer, the payment card issuer, for example payment card issuer 85 in FIG. 1, may send notifications to the user via the application notifying the user of rewards points bonuses for specific types of purchases made at the user's travel destination during the time period indicated. For example, a particular payment card issuer may normally reward one reward point for every dollar (or equivalent currency) spent in transactions using the issuer's payment card. If, however, the user indicates that the user will be traveling to a specific destination (e.g., Paris) for a specified time period (e.g., April), the payment card issuer may decide to offer bonus reward points for particular categories of purchases made in the indicated travel destination during the indicated time duration. For instance, the card issuer may offer three points for every dollar or equivalent spent at restaurants, five points for every dollar or equivalent spent at hotels, and two points for every dollar or equivalent spent shopping. It should be understood that these are merely examples of possible bonus reward points multipliers, and any other bonus multiplier may be used. In some embodiments, the bonus rewards points multiplier may apply to specific merchants instead of an entire category of merchants.

In some embodiments, an offer database may be stored on an offer server 95, as shown in FIG. 1, that is associated with a particular card issuer 85. The offer database may include the particularly types of bonus reward points multipliers that the payment card issuer 85 has determined for a set of travel locations and/or time durations. The card issuer 85 may modify the values of the bonus reward multipliers periodically either manually or via a pre-determined schedule. When the card issuer 85 receives a notification from the e-commerce enabler server 65 identifying the time period and destination for which a user intends to travel, the offer server 95 may refer to the offer database, identify whether any bonus reward multipliers apply to the indicated travel destination and/or time duration, and may transmit the notification reflecting the identified bonus reward points multiplier offer to the user via the e-commerce application. In some embodiments, the offer database may include information specific to the user that is considered in determining the particular bonus rewards offer multiplier. In some embodiments, the card issuer 85 may increase or decrease the value of the bonus rewards points multiplier during the trip based on the user's buying habits or the amount of the purchases transacted while traveling. In such embodiments, the offer server 95 may send a notification to the user via the e-commerce enabler application informing the user of the new bonus offer. In some embodiments, the bonus offer may include waiving or reducing foreign transaction fees for international traveling.

Because a user may have accounts with more than one payment card issuer and those accounts may all be stored and accessible by the e-commerce enabler application via the e-commerce enabler server 65, multiple card issuers may provide bonus reward points multipliers for an indicated travel destination and time period. In this way, different payment card issuers can compete to provide the user with an incentive to make transactions using a particular payment card while traveling during the indicated time period at the indicated travel destination. For example, a user may indicate via the e-commerce enabler application that the user will be traveling to Paris for the month of April, and may select Credit Card A and Credit Card B as payment cards the user may use while traveling. The e-commerce enabler may transmit notifications via the digital communication network 60 or payment network 75 to the card issuers of both Credit Card A and Credit Card B informing them where and when the user will be traveling. The issuer of Credit Card A may, in turn, send a notification to the user via the e-commerce enabler application that the user will receive a 5× rewards bonus (5 points per dollar spent) at restaurants for transactions made using Credit Card A, and the issuer of Credit Card B may send a notification via the e-commerce enabler application that the user will receive a 6× rewards bonus at restaurants for transactions made using Credit Card B. In such an example, the user may be incentivized to user Credit Card B instead of Credit Card A at restaurants while traveling so as to take advantage of the larger bonus rewards multiplier offered by Credit Card B.

In some embodiments, bonus rewards for other categories of purchases are also contemplated. In some embodiments, the e-commerce enabler application may allow the user to select a default payment card to use during the specified trip. The application may receive input from the computing device's 55 GPS location system in order to determine that the purchase is being made in the indicated location (e.g., Paris), and the application may refer to an internal calendar or receive input from a calendar application stored on the computing device in order to determine whether the transaction is initiated during the specified time duration. The application may then use the default payment card account for transactions made that fit the specified location and time duration criteria. Once the time period ends or the location no longer matches the indicated location, the e-commerce enabler application may revert to a different default payment card as previously determined by the user, or may provide and receive a selection of one of a variety of payment card accounts to use for a given transaction.

As the user continues to make purchases using the selected payment cards and payment accounts, the e-commerce enabler application may track the reward points earned during the trip and display the results to the user via notifications or modules accessible in the application. For example, the e-commerce enabler application may include a scoreboard module through which the application may display the reward points earned for each or specific categories of transactions during the trip. In some embodiments, the application may identify categories of transactions in which the user has not made any or many purchases and may encourage making transactions in those categories by offering higher bonus rewards points multipliers or other incentives. In some embodiments, the application may track the types of merchants at which the user has performed transactions on the trip and recommend other similar merchants. In some embodiments, the application may include a map module through which the application may alert the user to locations of those similar merchants. Additionally, the map module may be used to alert the user to merchants nearby the destination that fall within the categories of merchants eligible for bonus rewards points multipliers. In some embodiments, the map module may indicate specific merchants within a geographical radius at which transactions by the user may result in additional bonus rewards points multipliers.

In some embodiments, the e-commerce enabler application may include a sharing module through which the user may share the user's points accumulations with friends or other users. In some embodiments, the user may input into the sharing module a list of “friends” or contacts with which to share the scoreboard results or accumulated points during a trip. In other embodiments, the e-commerce enabler application may interface with other social media applications and networks. In some embodiments, the card issuer may offer additional rewards points to users who successfully refer other users to sign up or create accounts with that specific payment card issuer or to create an account with the e-commerce enabler.

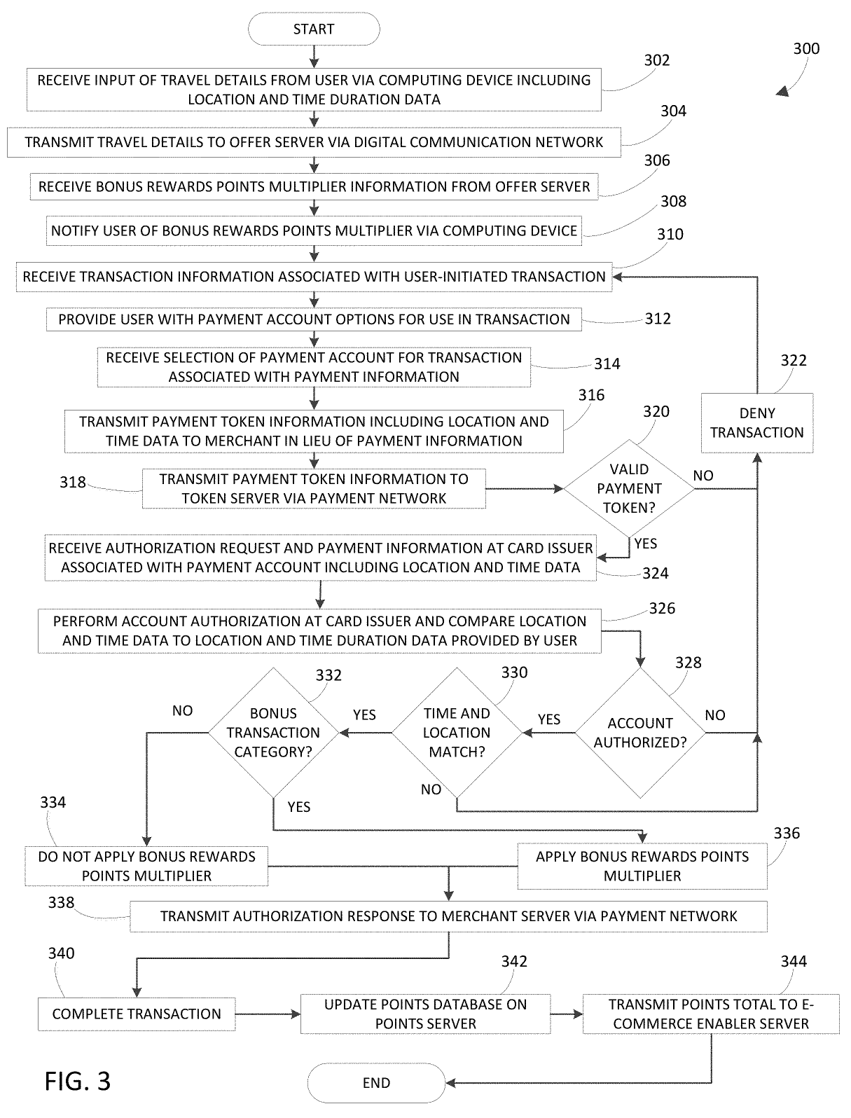

When a user initiates a purchase transaction using a payment card account associated with the card issuer 85 while traveling at a destination and during a time period previously entered into e-commerce enabler application as described above, the transaction may be securely authenticated using the payment token system. FIG. 3 illustrated an example process 300 by which a transaction made using a payment card account using a computing device 55 may be securely completed using the systems and methods described herein. At block 302, the e-commerce enabler application may receive the input of travel details from a user via the computing device 55. In some embodiments, the travel details may include a travel location and a time duration for the trip. At block 304, the e-commerce enabler server 65 may securely transmit the travel details to the card issuer 85 or, more particularly, to the offer server 95 associated with the card issuer, via the digital communications network 60. At block 306, the e-commerce enabler server 65 may receive bonus points reward multiplier information from the offer server 90 based on the bonus data applicable to the travel details. At block 308, the e-commerce enabler application may notify the user of the bonus rewards multiplier via the computing device 55. Although not illustrated in FIGS. 1 and 3, in some embodiments, the user may have accounts associated with more than one payment card. In such embodiments, the e-commerce enabler application may request and receive bonus rewards points multiplier information from multiple card issuers.

At block 310, the e-commerce enabler application may receive transaction information associated with a user-initiated transaction. In some embodiments, the transaction may be initiated via the e-commerce enabler application on the computing device 55. In some embodiments, the transaction may be initiated by connecting to a merchant computer device or server using near field communication (NFC) or other wireless technology. The transaction information may include data related to the price and an identifier of the good or service being purchased, the location of the transaction, and/or a transaction category of the good or service. At block 312, the e-commerce enabler application may provide the user with payment account options for use in the transaction if the user has multiple payment accounts stored in the e-commerce enabler server 65. At block 314, the e-commerce enabler application may receive a selection of the payment account that the user would like to use for initiated transaction. In some embodiments, the user may have previously indicated a default payment account to be used for the duration of a trip and, in such embodiments, the steps in blocks 312 and 314 may be omitted.

At block 316, the e-commerce enabler application may transmit payment token information to the merchant server 70 in lieu of the actual payment information associated with the user's payment account. As described with reference to FIG. 2 above, use of payment token information instead of the actual payment information may increase transaction security and reduce unauthorized transactions. In some embodiments, the payment token information may include geographical location data and time data associated with the transaction. In some embodiments, the location of the transaction may be received from the computing device's 55 GPS capabilities, and in other embodiments the location may be included in the transaction information. At block 318, the merchant server 70 may transmit the payment token information to the token server via the payment network 75, where the token service provider may perform a token information validation at block 320 as discussed above with reference to FIG. 2. If the validation fails, the transaction is denied at block 322. If the token validation is successful, at block 324 the payment network 75 and token server 80 may transmit and the card issuer 85 may receive an authorization request and payment information associated with the payment account. In some embodiments, the payment information may include the location data and time data that had been included in the payment token information or otherwise.

At block 326, the card issuer 85 may perform account authorization and may also compare the location and time data to the location and time duration data that had been previously provided by the user via the e-commerce enabler application. If the account authorization fails at block 328, the transaction may be denied at block 322. If the account is authorized, at block 330 the card issuer 85 may also verify whether the time data and location data match the user-provided time duration and location. If not, in some embodiments, the transaction may be denied at block 322 because the transaction requested is taking place at a location that the user is not expected to be. In some embodiments, failing to match the time and location may only result in a notification sent to the user. If the time and location data matches, the card issuer 85 may consult the offer server 90 to determine if the transaction falls into a bonus transaction category at block 332. If not, at block 334 no bonus rewards points multiplier is applied to the transaction and the user may be awarded standard, non-multiple rewards points. If the transaction does qualify in a bonus transaction category, card issuer 85 may award rewards points based on the applicable multiplier for the transaction category at block 336. For example, in some embodiments, if purchases at restaurants during the trip are to be granted a 5× bonus rewards point multiplier, a restaurant transaction for $100 using the card issuer's payment card account may result in 500 rewards points.

At block 338, the card issuer 85 may transmit an authorization response to the merchant server 70 indicating that the transaction is authorized. The merchant may then complete the transaction at block 340, and the points database on the points server 95 may be updated to reflect the new rewards points total associated with the user's payment account at block 342. Additionally, at block 344, the points server 95 may transmit the points total to the e-commerce enabler server 65 so that the e-commerce enabler application may display the updated points total to the user through the points module or through a notification.

The system and methods for rewards points incentives described and shown herein may have several uses and address several technical problems. When traveling, consumers tend to make abnormally large numbers of transactions in certain transaction categories, such as restaurants, hotel or other lodging, taxi cab or other driver services, etc. Travelers, particularly international travelers, may tend to make more purchases with credit cards when traveling abroad so as to limit the need to exchange for local currencies. Using the systems and methods described herein, a payment card issuer can provide added incentive for a traveler to use that card issuer's payment card when traveling as opposed to other payment cards the user may have. The system and methods may also enhance the security of credit card transactions because the card issuer may recognize that transactions made outside the geographical travel location that the user indicated may be flagged as potentially unauthorized. Thus, credit card transactions which may not have occurred in the past will now occur using the disclosed system and methods. With greater security and additional rewards incentive, users will be more confident in using the payment card or associated payment accounts more frequently, resulting in additional transactions and sales. Additionally, users will have added incentive to report their intended travel destinations to the payment card issuer in order to receive bonus rewards points for the user's purchases.

The system and methods are more than just speeding a process but instead uses a computing system to achieve a new and better outcome. The system and methods disclosed herein provide users and payment card issuers with greater access to payment method security and intended spending habits that were not previously available, while providing the user with incentives to disclose travel plans. In doing so, the system and methods override the routine and conventional sequence of a events normally used in providing rewards points for credit card users. Users are incentivized to disclose travel information prior to traveling so they will be able to earn bonus rewards points for transactions made while traveling. This is different than the routine and conventional sequence of events that generally does not involve providing bonus rewards points for transactions specifically made during a pre-disclosed trip. The routine and conventional sequence of events would not incentivize users to disclose their travel plans prior to the trip, thus limiting the card issuer from the authentication and security procedures described herein.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s). Alternatively, the user devices, computers and servers described herein may be special purpose computer devices and servers designed specifically for the tasks and routines disclosed.

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated. The attached Appendix may provide more detail regarding the operation of a payment system.

The present disclosure provides a solution to the long-felt need described above. In particular, the systems and methods described herein may be configured for improving payment systems. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A computer-implemented method of incentivizing secure transactions, the method comprising:
receiving, via a digital communication network, an input of future travel details including future travel location data and future travel time data from a user via a user computing device;
transmitting travel details to an offer server, the offer server being associated with a payment card issuer;
determining, via one or more processors, bonus multiplier information based on the travel details, the bonus multiplier information being indicative of a bonus multiplier;
transmitting, via the digital communication network, the bonus multiplier information to the user computing device;
receiving, via a payment network, a transaction authorization request associated with a user-initiated transaction, wherein the transaction authorization request includes transaction location data and transaction time data, and wherein the transaction authorization request includes a transaction amount;
verifying, via one or more processors, that the transaction location data matches the travel location data and that the transaction time data matches the travel time data;
transmitting an authorization response via the payment network; and
determining, via the one or more processors, a new rewards points amount by applying the bonus multiplier to the transaction amount.

2. The computer-implemented method of claim 1, wherein the transaction authorization request further comprises payment information associated with a user account, and further comprising verifying that the user account is authorized to complete the transaction.

3. The computer-implemented method of claim 1, wherein the bonus multiplier information further comprises at least one eligible merchant category.

4. The computer-implemented method of claim 3, wherein the transaction is between the user and a merchant, and wherein the transaction authorization request further comprises merchant category information indicative of a merchant category of the merchant.

5. The computer-implemented method of claim 4, further comprising verifying, via one or more processors, that the merchant category indicated by the merchant category information matches the at least one eligible merchant category.

6. The computer-implemented method of claim 1, wherein applying the bonus multiplier to the transaction amount further comprises:
transmitting the new rewards points amount to a points server, the points server including a rewards points database; and
updating the rewards points database to reflect the new rewards points amount.

7. The computer-implemented method of claim 1, further comprising transmitting, via the digital communication network, the new rewards points amount to the user computer device.

8. The computer-implemented method of claim 1, wherein the future travel details are received prior to a time indicated in the future travel time data and received from a geographic location different from a geographic location indicated in the future travel location data.

9. The computer-implemented method of claim 1, wherein the transaction authorization request further comprises payment information associated with a user account, wherein the payment information has been authenticated by a token server.

10. A computer-implemented method of incentivizing secure transactions, the method comprising:
receiving, via a digital communication network, future travel location data and future travel time data from a user computing device;
determining, via one or more processors, a bonus multiplier based on the future travel location data and the future travel time data;
transmitting, via the digital communication network, bonus multiplier information to the user computing device, the bonus multiplier information being indicative of the bonus multiplier and including at least one eligible merchant category;
receiving, via a payment network, a transaction authorization request associated with a transaction, wherein the transaction authorization request includes:
transaction location data and transaction time data,
a transaction amount, and
merchant category information indicative of a merchant category;
determining, via the one or more processors, that the transaction location data matches the travel location data and that the transaction time data matches the travel time data;
based on the determination that the transaction location data matches the travel location data and that the transaction time data matches the travel time data, transmitting an authorization response via the payment network;
determining, via the one or more processors, that the merchant category indicated by the merchant category information matches the at least one eligible merchant category; and
based on the determination that the merchant category indicated by the merchant category information matches the at least one eligible merchant category, determining, via the one or more processors, a new rewards points amount by applying the bonus multiplier to the transaction amount.

11. The method of claim 10, wherein the transaction authorization request further comprises payment information associated with a user account, and further comprising verifying that the user account is authorized to complete the transaction.

12. The method of claim 10, wherein applying the bonus multiplier to the transaction amount further comprises updating a rewards points total associated with the user account to reflect the new rewards points amount.

13. The method of claim 12, further comprising transmitting the updated rewards points total to the user computing device.

14. The computer-implemented method of claim 10, wherein applying the bonus multiplier to the transaction amount further comprises:
transmitting the new rewards points amount to a points server, the points server including a rewards points database; and
updating the rewards points database to reflect the new rewards points amount.

15. The computer-implemented method of claim 10, wherein the future travel details are received prior to a time indicated in the future travel time data and received from a geographic location different from a geographic location indicated in the future travel location data.

16. The computer-implemented method of claim 10, wherein the transaction authorization request further comprises payment information associated with a user account, wherein the payment information has been authenticated by a token server.

17. The computer-implemented method of claim 10, further comprising determining, via the one or more processors, a new bonus multiplier based on transaction information included in the transaction authorization request.

18. The computer-implemented method of claim 17, further comprising transmitting, via the digital communication network, new bonus multiplier information to the user computing device, the new bonus multiplier information being indicative of the new bonus multiplier and including at least one eligible merchant category.

19. A computer-implemented method of incentivizing secure transactions, the method comprising:
receiving, via a digital communication network, an input of future travel details including future travel location data and future travel time data from a user via a user computing device;
transmitting travel details to an offer server, the offer server being associated with a payment card issuer;
determining, via one or more processors, bonus multiplier information based on the travel details, the bonus multiplier information being indicative of a bonus multiplier;
transmitting, via the digital communication network, the bonus multiplier information to the user computing device;
receiving, via a payment network, a transaction authorization request associated with a transaction, wherein the transaction authorization request includes transaction location data and transaction time data;
determining, via one or more processors, at least one of that the transaction location data does not match the future travel location data or that the transaction time data does not match the travel time data; and
based on the determination that either the transaction location data does not match the future travel location data or that the transaction time data does not match the travel time data, transmitting a transaction denial via the payment network.

20. The computer-implemented method of claim 19, wherein the future travel details are received prior to a time indicated in the future travel time data and received from a geographic location different than a geographic location indicated in the future travel location data.
